(19) United States
(12) Patent Application Publication
(10) Pub. No.: US 2026/0160115 A1
(43) Pub. Date: Jun. 11, 2026

(54) METHOD FOR CONTROLLING TIMING LOCK BOX

(71) Applicant: Hao KANG, Chongqing (CN)

(72) Inventor: Hao KANG, Chongqing (CN)

(21) Appl. No.: 19/001,828

(22) Filed: Dec. 26, 2024

(30) Foreign Application Priority Data
Dec. 6, 2024 (CN) 2024118081948

(51) Int. Cl. E05G 1/10; E05G 1/00

(52) U.S. Cl. CPC E05G 1/10; E05G 1/005; E05G 2700/02

(57) ABSTRACT

Disclosed in the present application is a method for controlling a timing lock box. The method for controlling a timing lock box includes the following steps: receiving an expected unlocking moment set by a user, time information represented by the expected unlocking moment including year, month, day, hour, and minute information; locking a lock of the timing lock box; determining whether the expected unlocking moment is reached; and in response to reaching the expected unlocking moment, controlling the lock to be unlocked at the expected unlocking moment.

### TECHNICAL FIELD

The present application relates to the field of time locks, and particularly discloses a method for controlling a timing lock box.

### BACKGROUND

A timing lock box refers to a box capable of being unlocked at a fixed time. An article needed to be locked in the timing lock box can be placed in the timing lock box. In certain time, the timing lock box can be automatically unlocked, so that a user can take out the article from the timing lock box. The timing lock box can be used in application scenarios such as smoking abstinence, mobile phone abstinence, and game machine abstinence.

However, existing timing lock boxes have some limitations in actual applications. For example, the unlocking time can only be set and determined by way of counting down. For example, the timing lock box can only be unlocked in 3 hours, or can be unlocked in other time periods. For another example, time can only be set to hour and minute and cannot be set to year, month, and day. For yet another example, the timing lock boxes rely on Internet time.

### SUMMARY

An advantage of the present application is to provide a method for controlling a timing lock box. The method for controlling a timing lock box can directly set the unlocking moment, i.e., directly set that the timing lock box is unlocked at an appointed moment.

Another advantage of the present application is to provide a method for controlling a timing lock box. The method for controlling a timing lock box cannot only directly set the unlocking moment, but also set the unlocking time by way of counting down, i.e., the timing lock box is unlocked in a certain time.

Yet another advantage of the present application is to provide a method for controlling a timing lock box. The method for controlling a timing lock box can set and display time based on a perpetual calendar method.

Yet another advantage of the present application is to provide a method for controlling a timing lock box. The method for controlling a timing lock box can time according to local time without relying on the Internet.

According to an aspect of the present application, provided is a method for controlling a timing lock box, including the following steps: receiving an expected unlocking moment set by a user, time information represented by the expected unlocking moment including year, month, day, hour, and minute information; locking a lock of the timing lock box; determining whether the expected unlocking moment is reached; and in response to reaching the expected unlocking moment, controlling the lock to be unlocked at the expected unlocking moment.

In an implementation of the method for controlling a timing lock box according to the present application, whether the expected unlocking moment is reached is determined based on local time.

In an implementation of the method for controlling a timing lock box according to the present application, the method for controlling a timing lock box further includes the following step: controlling a display screen to display the expected unlocking moment and/or countdown time, the countdown time being used to express a time difference value between the expected unlocking moment and current time.

In an implementation of the method for controlling a timing lock box according to the present application, in the process of controlling the display screen to display the expected unlocking moment and/or countdown time, the display screen is controlled to synchronously display the expected unlocking moment and countdown time, or the display screen is controlled to asynchronously display the expected unlocking moment and countdown time.

In an implementation of the method for controlling a timing lock box according to the present application, the method for controlling a timing lock box further includes the following steps: receiving an updated expected unlocking moment; and controlling a state of the lock based on the updated expected unlocking moment.

In an implementation of the method for controlling a timing lock box according to the present application, the controlling a state of the lock based on the updated expected unlocking moment includes the following step: in response to the updated expected unlocking moment later than the expected unlocking moment before update, upon reaching the updated expected unlocking moment, controlling the lock to be unlocked at the updated expected unlocking moment.

In an implementation of the method for controlling a timing lock box according to the present application, the controlling a state of the lock based on the updated expected unlocking moment includes the following steps: in response to the updated expected unlocking moment earlier than the expected unlocking moment before update, waiting to receive password information; in response to receiving correct password information, immediately unlocking, upon reaching the updated expected unlocking moment, controlling the lock to be unlocked at the expected unlocking moment; and in response to receiving wrong password information or not receiving the password information within expected time, keeping an unlocking moment as the expected unlocking moment before update.

According to another aspect of the present application, the present application provides a timing lock box, including: a box body, a lock, and a controller, where the lock is mounted in the box body; and a controller is adapted to control a state of the lock by the method for controlling a timing lock box described above.

According to yet another aspect of the present application, the present application provide an electronic device, including a memory and a processor, a computer program instruction being stored in the memory, where the computer program instruction, when run by the processor, causes the processor to execute the method for controlling a timing lock box described above.

According to yet another aspect of the present application, the present application provide a computer-readable storage medium, storing a computer program instruction, where the computer program instruction is adapted to, when run by the processor, cause the processor to execute the method for controlling a timing lock box according to any one of claims 1-7.

Further objects and advantages of the present application will be fully reflected by subsequently understanding the description and drawings.

These and other objects, characteristics, and advantages of the present application are fully reflected through detailed descriptions, drawings, and claims below.

### BRIEF DESCRIPTION OF THE DRAWINGS

The exemplary embodiments of the present application are described in further detail in conjunction with drawings, and the above and other objects, features, and advantages of the present application will become more apparent. The drawings are used to provide a further understanding of the embodiment of the present application and constitute a part of the specification. They are used together with the embodiments of the present application to explain the present application and do not constitute a limitation to the present application. In the drawings, the same numerals usually represent the same components.

FIG. 1 is a three-dimensional schematic diagram of a timing lock box according to the embodiment of the present application.

FIG. 2 is a schematic diagram of an interface displayed by a display screen for the timing lock box according to the embodiment of the present application.

FIG. 3 is a schematic diagram of a structural block diagram for a timing lock box according to the embodiment of the present application.

FIG. 4 is a schematic diagram of a flowchart of a method for controlling a timing lock box according to the embodiment of the present application.

FIG. 5 is a schematic diagram of a structural block diagram of an electronic device according to the embodiment of the present application.

### DETAILED DESCRIPTION OF THE EMBODIMENTS

Exemplary embodiments according to the present application will be described in detail with reference to drawings below. Apparently, the described embodiments are merely a part of embodiments of the present application and are not all the embodiments. It shall be understood that the present application is not limited by the exemplary embodiments described herein.

It may be understood that the term “one” shall be understood as “at least one” or “one or more”, i.e., in an embodiment, the number of one component may be one, and in other embodiments, the number of the component may be plural. The term “one” may not be understood as a limitation to the number. “More” refers to greater than or equal to two.

Although the ordinal numbers such as “first” and “second” will be used to describe various assemblies, these assemblies are not limited herein. The term is merely used to distinguish one assembly from another assembly. For example, the first assembly may also be referred to as the second assembly, and similarly, the second assembly may also be referred to as the first assembly without departing from teaching of the concept of the present application. The term “and/or” used herein includes any and all combinations of one or more correlative listed items.

The terms used herein are merely used for describing various embodiments rather than limiting the present application. As used herein, the singular form may also include the plural forms as well, unless the context clearly indicates otherwise. In addition, it will be appreciated that the terms “include” and/or “have” assign existence of features, number, operations, assemblies, components or combinations thereof when used in the description, rather than excluding existence or addition of one or more features, number, operations, assemblies, components or combinations thereof.

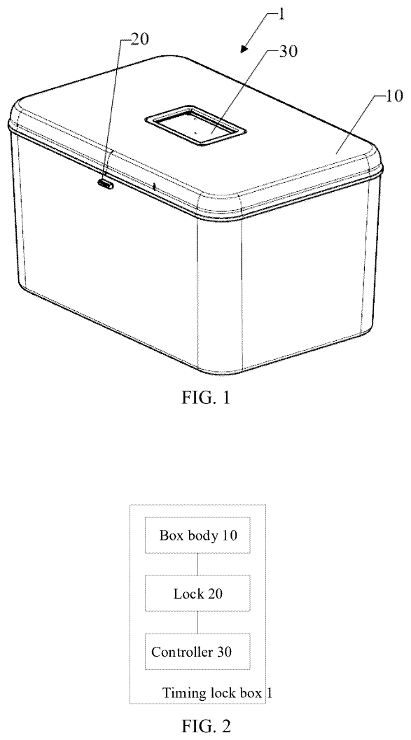

As shown in FIGS. 1-3, the timing lock box 1 according to the embodiment of the present application is illustrated. As shown in FIG. 1 and FIG. 2, the timing lock box 1 includes a box body 10, a lock 20, and a controller 30. The box body 10 has accommodating space to accommodate articles such as a mobile phone, a computer, a game machine, and cigarettes. The lock 20 is mounted in the box body 10 to control the state of the box body 10. When the box body 10 is in a closed state and the lock 20 is in a locked state, the box body 10 is in a locked state. When the lock 20 is in an unlocked state, the box body 10 is in an unlocked state and can be opened or closed. The controller 30 is adapted to control the state of the lock 20 by the method for controlling a timing lock box provided by the present application.

In an application of the timing lock box 1 according to the present application, the user can place the article needed to be locked in the timing lock box 1 in the timing lock box 1 and set the expected unlocking moment, so that the timing lock box 1 is unlocked at the set expected unlocking moment, and therefore, the article is taken out from the timing lock box 1. In other words, the timing lock box 1 according to the present application can be unlocked at the appointed moment (i.e., the expected unlocking moment) through the unlocking moment directly set by the user.

It is worth noting that in an implementation of the present application, the user can also place the article needed to be locked in the timing lock box 1 in the timing lock box 1 and set the countdown time, so that the timing lock box 1 is unlocked after the countdown time, and therefore, the article is taken out from the timing lock box 1. The countdown time is used to express a time difference value between the expected unlocking moment and the current time.

In other words, in the implementation, the timing lock box 1 according to the present application can be unlocked at the appointed moment (i.e., the expected unlocking moment) through the unlocking moment directly set by the user, and can also be unlocked in a certain period of time at the unlocking time set by way of counting down.

It is further worth noting that in an implementation of the present application, the timing lock box 1 sets and displays time based on a perpetual calendar method. The expected unlocking moment is displayed in the form of XX minute, XX hour, XX day, XX month, XX year. The countdown time can be displayed in the form of XX minute, XX hour, XX day, XX month, XX year. Correspondingly, time information represented by the expected unlocking moment includes year, month, day, hour, and minute information. Time information represented by the countdown time includes year, month, day, hour, and minute information.

In the timing lock box 1 according to the present application, a display screen is arranged and the display screen is connected to the controller 30. The display screen can be used by the user to operate and/or display the state of the timing lock box 1.

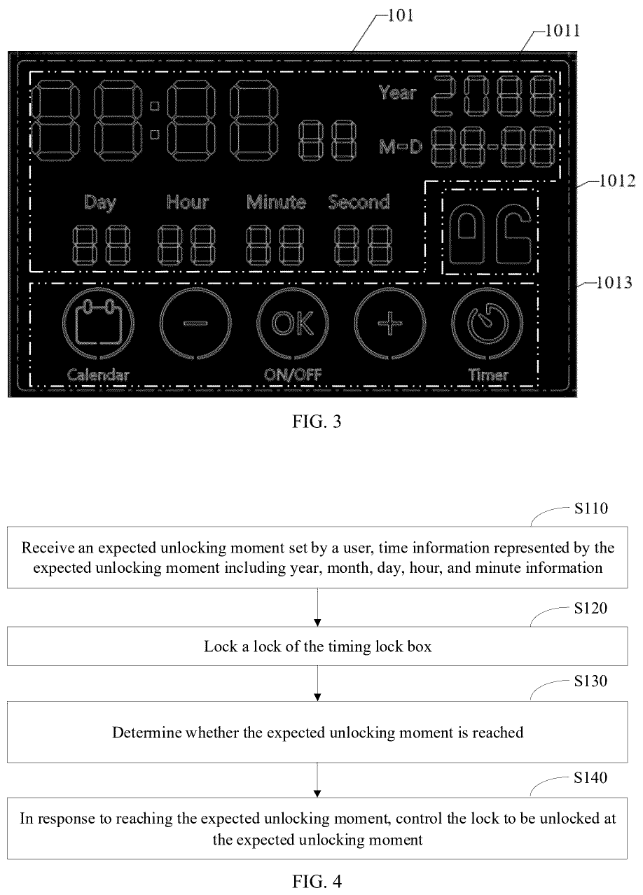

Specifically, as shown in FIG. 3, in an implementation of the present application, the interface 101 displayed by the display screen includes a time display area 1011, a locked state display area 1012, and a setting area 1013.

The time display area 1011 is used to display the expected unlocking moment and/or the countdown time. Correspondingly, in an example of the present application, the time display area 1011 includes a year display area, a month display area, a day display area of the expected unlocking moment, a hour display area of the expected unlocking moment, a minute display area of the expected unlocking moment, a hour display area of the countdown time, and a minute display area of the countdown time.

The locked state display area 1012 is used to display a locked state of the lock 20 of the timing lock box 1, for example, the locked state and the unlocked state.

The setting area 1013 is used by the user to control an on-off state, the expected unlocking moment and/or the countdown time of the timing lock box 1. In an example of the present application, the setting area 1013 includes an on-off setting area 1013 to control on-off of the timing lock box 1. When the timing lock box 1 is in an on state, the timing lock box 1 can be set with the expected unlocking moment and/or the countdown time; and when the timing lock box 1 is in an off state, the controller 30, the lock 20, the display screen and the like of the timing lock box 1 stop working. The setting area 1013 further includes a mode setting area 1013. The mode setting area 1013 is used to set a time setting mode, so that the timing lock box 1 enters an expected unlocking moment setting mode or a countdown time setting mode. When the timing lock box 1 is in the expected unlocking moment setting mode, the user is allowed to directly set the unlocking moment, i.e., the user is allowed to directly set that the timing lock box 1 is unlocked at the appointed moment (i.e., the expected unlocking moment). When the timing lock box 1 is in the countdown setting mode, the user is allowed to set the unlocking time by way of counting down, i.e., the user is allowed to set that the timing lock box is unlocked in a certain period of time (i.e., the countdown time). The setting area 1013 further includes a time setting area 1013, and the time setting area 1013 is used to set specific numerical values of the expected unlocking moment and/or the countdown time. The user may change the expected unlocking moment and/or the countdown time after timing. The timing lock box 1 may perform new timing according to the changed expected unlocking moment and/or countdown time. In an implementation of the present application, the user needs to input a unlocking password when the expected unlocking moment is postponed and/or advanced. It shall be appreciated that in other implementations, the user does not need to input the unlocking password when the expected unlocking moment is postponed and/or advanced.

It shall be appreciated that the timing lock box 1 may not be provided with the display screen. Further, the timing lock box 1 may be communicatively connected to a terminal device (for example, a mobile phone) and displays the expected unlocking moment and/or the countdown time, the locked state of the timing lock box 1, and the like on the display screen of the terminal device (for example, the mobile phone). User operations may be realized by virtue of the display screen of the terminal device (for example, the mobile phone), so that the user may set the expected unlocking moment and/or the countdown time and on-off of the timing lock box 1 through the display screen of the terminal device (for example, the mobile phone).

Correspondingly, in an implementation of the present application, the timing lock box 1 further includes a wireless communication module, for example, a Bluetooth module and a wifi module.

It is further worth noting that in an implementation of the present application, the timing lock box 1 times based on the local time, which can reduce relying on the Internet.

The timing lock box 1 further includes a power supply, electrically connected to the lock 20 and the controller 30 to supply electricity to the lock 20 and the controller 30. The power supply may be implemented as either a dry battery or a rechargeable battery.

As described above, the controller 30 is adapted to control the state of the lock 20 by the method for controlling a timing lock box provided by the present application. Specifically, when the timing lock box 1 is in the expected unlocking moment setting mode, as shown in FIG. 4, the method for controlling a timing lock box includes the following steps: S110, receiving an expected unlocking moment set by a user, time information represented by the expected unlocking moment including year, month, day, hour, and minute information; S120, locking a lock of the timing lock box 1; S130, determining whether the expected unlocking moment is reached; and S140, in response to reaching the expected unlocking moment, controlling the lock to be unlocked at the expected unlocking moment.

In step S110, the expected unlocking moment set by the user is received. Specifically, the user may set the expected unlocking moment through the terminal device (for example, the mobile phone) communicatively connected to the display screen of the timing lock box 1 and/or the timing lock box 1. The expected unlocking moment is displayed in the form of XX minute, XX hour, XX day, XX month, XX year. Correspondingly, time information represented by the expected unlocking moment includes year, month, day, hour, and minute information.

After the user sets the expected unlocking moment, the controller 30 may acquire the countdown time based on the expected unlocking moment and current time. The countdown time is used to express a time difference value between the expected unlocking moment and the current time. Further, the controller 30 may control the display screen to display the expected unlocking moment and/or the countdown time.

In the process of controlling the display screen to display the expected unlocking moment and/or countdown time, the display screen may be controlled to synchronously display the expected unlocking moment and countdown time, or the display screen may be controlled to asynchronously display the expected unlocking moment and countdown time.

In step S120, a lock of the timing lock box 1 is locked. Specifically, when the lock of the timing lock box 1 is locked, the box body 10 of the timing lock box 1 is in the locked state. The user can hardly take out articles from the timing lock box 1.

In step S130, whether the expected unlocking moment is reached is determined. In an implementation of the present application, whether the expected unlocking moment is reached is determined based on local time. In a transformed implementation of the present application, whether the expected unlocking moment is reached may be determined based on network time.

In step S140, in response to reaching the expected unlocking moment, the lock is controlled to be unlocked at the expected unlocking moment. Specifically, when the lock is unlocked at the expected unlocking moment, the box body 10 of the timing lock box 1 is in the unlocked state and may be opened or closed.

In an implementation of the present application, the method for controlling a timing lock box further includes the following steps: S150, receiving an updated expected unlocking moment; and S160, controlling a state of the lock based on the updated expected unlocking moment.

In the process of controlling the state of the lock based on the updated expected unlocking moment, upon reaching the updated expected unlocking moment, the lock is controlled to be unlocked at the expected unlocking moment; or, upon receiving the updated expected unlocking moment, it is to wait to receive password information; then, in response to receiving correct password information, unlocking is performed immediately; and in response to receiving wrong password information or not receiving the password information within expected time, an unlocking moment is kept as the expected unlocking moment before update.

In an example of the present application, the controlling a state of the lock based on the updated expected unlocking moment includes the following step: in response to the updated expected unlocking moment later than the expected unlocking moment before update, upon reaching the updated expected unlocking moment, controlling the lock to be unlocked at the updated expected unlocking moment. The controlling a state of the lock based on the updated expected unlocking moment includes the following steps: in response to the updated expected unlocking moment earlier than the expected unlocking moment before update, waiting to receive password information; in response to receiving correct password information, immediately unlocking, upon reaching the updated expected unlocking moment, controlling the lock to be unlocked at the expected unlocking moment; and in response to receiving wrong password information or not receiving the password information within expected time, keeping an unlocking moment as the expected unlocking moment before update.

When the timing lock box 1 is in the countdown time setting mode, the method for controlling a timing lock box includes the following steps: S110A, receiving countdown time set by a user; S120A, locking a lock of the timing lock box 1; S130A, determining whether the countdown time is reached; and S140A, in response to reaching the countdown time, controlling the lock to be unlocked at the expected unlocking moment.

In step S110A, the countdown time set by the user is received. Specifically, the user may set the countdown time through the terminal device (for example, the mobile phone) communicatively connected to the display screen of the timing lock box 1 and/or the timing lock box 1. The countdown time is displayed in the form of XX minute, XX hour, XX day, XX month, XX year. Correspondingly, time information represented by the countdown time includes year, month, day, hour, and minute information.

After the user sets the countdown time, the controller 30 may acquire the expected unlocking moment based on the countdown time and current time. Further, the controller 30 may control the display screen to display the countdown time and/or the countdown time.

In the process of controlling the display screen to display the countdown time and/or countdown time, the display screen may be controlled to synchronously display the countdown time and countdown time, or the display screen may be controlled to asynchronously display the countdown time and countdown time.

In step S120A, a lock of the timing lock box 1 is locked. Specifically, when the lock of the timing lock box 1 is locked, the box body 10 of the timing lock box 1 is in the locked state. The user can hardly take out articles from the timing lock box 1.

In step S130A, whether countdown is finished is determined. In an implementation of the present application, whether countdown is finished is determined based on local time. In a transformed implementation of the present application, whether countdown is finished may be determined based on network time.

In step S140A, in response to determining whether countdown is finished, the lock is controlled to be unlocked at the countdown time. Specifically, when the lock is unlocked at the countdown time, the box body 10 of the timing lock box 1 is in the unlocked state and may be opened or closed.

In an implementation of the present application, the method for controlling a timing lock box further includes the following steps: S150A, receiving updated countdown time; and S160A, controlling a state of the lock based on the updated countdown time.

In the process of controlling the state of the lock based on the updated countdown time, upon reaching the updated countdown time, the lock is controlled to be unlocked at the countdown time; or, upon receiving the updated countdown time, it is to wait to receive password information; then, in response to receiving correct password information, upon reaching the updated countdown time, the lock is controlled to be unlocked at the countdown time; and in response to receiving wrong password information or not receiving the password information within expected time, an unlocking moment is kept as the countdown time before update.

In an example of the present application, the controlling a state of the lock based on the updated countdown time includes the following step: in response to the updated countdown time later than the countdown time before update, upon reaching the updated countdown time, controlling the lock to be unlocked at the updated countdown time. The controlling a state of the lock based on the updated countdown time includes the following steps: in response to the updated countdown time earlier than the countdown time before update, waiting to receive password information; in response to receiving correct password information, upon receiving the updated countdown time, controlling the lock to be unlocked at the countdown time; and in response to receiving wrong password information or not receiving the password information within expected time, keeping an unlocking moment as the countdown time before update.

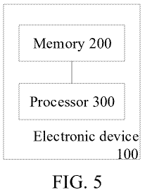

According to the method for controlling a timing lock box, the present application provides an electronic device, as shown in FIG. 5, the electronic device 100 including a memory 200 and a processor 300, a computer program instruction being stored in the memory 200, where the computer program instruction, when run by the processor 300, causes the processor 300 to execute the method for controlling a timing lock box described above.

According to the method for controlling a timing lock box, the present application further provides a computer-readable storage medium, storing a computer program instruction, where the computer program instruction is adapted to, when run by the processor, cause the processor to execute the method for controlling a timing lock box described above.

In conclusion, the timing lock box 1, the method for controlling a timing lock box, an electronic device 100, and a computer-readable storage medium according to the embodiments of the present application are illustrated. The method for controlling a timing lock box can directly set the unlocking moment, i.e., directly set that the timing lock box 1 is unlocked at an appointed moment and can time based on a perpetual calendar method.

The present application and the implementations thereof are described as above, and the description is not limiting; and what is shown in the drawings is only one of the implementations of the present application, and the actual structure is not limited thereto. All in all, if those of ordinary skill in the art are inspired by the present application, and designs, without departing from the purpose of the present application, structural modes, and embodiments similar to the technical solutions without inventive step, they shall fall within the scope of protection of the present application.

What is claimed is:

1. A method for controlling a timing lock box, comprising the following steps:
receiving an expected unlocking moment set by a user, time information represented by the expected unlocking moment comprising year, month, day, hour, and minute information;
locking a lock of the timing lock box;
determining whether the expected unlocking moment is reached; and
in response to reaching the expected unlocking moment, controlling the lock to be unlocked at the expected unlocking moment.

2. The method for controlling a timing lock box according to claim 1, wherein whether the expected unlocking moment is reached is determined based on local time.

3. The method for controlling a timing lock box according to claim 1, further comprising the following step: controlling a display screen to display the expected unlocking moment and/or countdown time, the countdown time being used to express a time difference value between the expected unlocking moment and current time.

4. The method for controlling a timing lock box according to claim 3, wherein in the process of controlling the display screen to display the expected unlocking moment and/or countdown time, the display screen is controlled to synchronously display the expected unlocking moment and countdown time, or the display screen is controlled to synchronously display the expected unlocking moment and countdown time.

5. The method for controlling a timing lock box according to claim 1, further comprising the following steps:
receiving an updated expected unlocking moment; and
controlling a state of the lock based on the updated expected unlocking moment.

6. The method for controlling a timing lock box according to claim 5, wherein the controlling a state of the lock based on the updated expected unlocking moment comprises the following step: in response to the updated expected unlocking moment later than the expected unlocking moment before update, upon reaching the updated expected unlocking moment, controlling the lock to be unlocked at the updated expected unlocking moment.

7. The method for controlling a timing lock box according to claim 5, wherein the controlling a state of the lock based on the updated expected unlocking moment comprises the following steps: in response to the updated expected unlocking moment earlier than the expected unlocking moment before update, waiting to receive password information; in response to receiving correct password information, immediately unlocking, upon reaching the updated expected unlocking moment, controlling the lock to be unlocked at the expected unlocking moment; and in response to receiving wrong password information or not receiving the password information within expected time, keeping an unlocking moment as the expected unlocking moment before update.

8. A timing lock box, comprising:
a box body;
a lock, mounted in the box body; and
a controller, adapted to control a state of the lock by the method for controlling a timing lock box according to claim 1.

9. An electronic device, comprising:
a memory; and
a processor, a computer program instruction being stored in the memory, wherein the computer program instruction, when run by the processor, causes the processor to execute the method for controlling a timing lock box according to claim 1.

10. A computer readable storage medium, storing a computer program instruction, wherein the computer program instruction is adapted to, when run by the processor, cause the processor to execute the method for controlling a timing lock box according to claim 1.
